(19) United States
(12) Patent Application Publication
(10) Pub. No.: US 2026/0281359 A1
(43) Pub. Date: Sep. 17, 2026

(54) METHODS AND SYSTEMS FOR DEEP LEARNING BASED INTERPOLATION OF VIDEO FRAMES

(71) Applicant: Portland State University, Portland, OR (US)

(72) Inventors: Wu-Chi Feng, Tigard, OR (US); Feng Liu, Beaverton, OR (US)

(21) Appl. No.: 19/472,081

(22) PCT Filed: Apr. 8, 2024
(86) PCT No.: PCT/US2024/023638

§ 371 Date: Oct. 2, 2025

Related U.S. Application Data
(60) Provisional application No. 63/495,066, filed on Apr. 7, 2023.

(51) Int. Cl. H04N 19/132; H04N 19/172; H04N 19/42

(52) U.S. Cl. CPC H04N 19/132; H04N 19/172; H04N 19/42

(57) ABSTRACT

Systems and methods for deep learning based video frame interpolation are disclosed. In some embodiments, a method for interpolating video frames may comprise receiving a series of input video frames including a first higher-resolution frame, a second higher-resolution frame, and a lower-resolution intermediate frame having an intermediate temporal position of the series between the first and second higher-resolution frames. The lower-resolution intermediate frame may be upscaled to create an upscaled intermediate frame, and the first higher-resolution frame, the second higher-resolution frame, and the upscaled intermediate frame may be concatenated to produce a concatenated frame. The concatenated frame may be inputted to a trained video frame interpolation (VFI) model, and an interpolated frame may be outputted from the trained VFI model, the interpolated frame having the intermediate temporal position of the series.

### CROSS REFERENCE TO RELATED APPLICATIONS

This application claims priority to U.S. Provisional Application No. 63/495,066, entitled “METHODS AND SYSTEMS FOR DEEP-LEARNING-BASED INTERPOLATION OF VIDEO FRAMES,” and filed Apr. 7, 2023, the entire contents of which are hereby incorporated by reference for all purposes.

### FIELD

This disclosure relates to video frame interpolation, more particularly to deep-learning-based interpolation.

### BACKGROUND

The use of digital video has become widespread and is still expanding in many industries and fields of endeavor. Applications such as computer vision, surveillance, and ultra-low-latency real-time video conferencing are likely to continue driving demand for the handling of high-quality digital video. New technologies such as ever-higher-resolution video (e.g., 8K video), virtual reality, and augmented reality also place demands on the handling of video content. Such uses can benefit from more-efficient techniques to capture, compress, transmit, and/or store digital video.

Discrete cosine transform (DCT) based compression techniques, e.g., coder/decoders (codecs), have been a common way to compress digital image data, both for still images and video images. In the case of video images, compression standards have evolved largely through increasing search options including finer-grained motion estimation, supporting more block-size choices for estimation, and expanding the existing data that can be referenced (e.g., intra-frame references and multiple frame references). To achieve higher compression performance, successive versions have required ever more computation power. Current hand-crafted video codecs are well-engineered, but as the resolution and quality of digital video continue to increase, traditional video codecs are approaching the limits of what can be optimized in compression.

In DCT-based compression techniques, all data is explicitly accounted for via a combination of direct encoding, motion estimation reference, and residual coding. In comparison, in deep-learning-based compression techniques, the goal is to have one or more neural networks predict or auto-generate at least some image data in a frame, and add residual coding if desired. In other words, the goal is to largely skip explicitly coding data as much as possible.

With the availability of commodity general-purpose graphics processing units (GPUs), deep learning (e.g., machine learning) video compression techniques are emerging as a potentially viable alternative to DCT-based video compression techniques.

However, Deep-learning-based video-frame interpolation (VFI) techniques, which may use one or more convolutional neural networks (CNNs) to design an auto-encoder, or one or more recurrent neural networks (RNNs) to build progressive image compression schemes, may exhibit quality issues when attempting to interpolate frames in situations of large motion, non-linear motion, and/or heavy occlusion between frames.

### SUMMARY

The inventors have perceived limitations, weaknesses, and various problems in various approaches to applying deep learning techniques to video compression, and have established an approach that mitigates these problems. This approach leverages both advantages of traditional video codecs and newer deep-learning-based VFI techniques, while minimizing the disadvantages thereof. In this approach, a low-resolution frame-a “hint frame”-provides hints to a deep learning framework in order to improve the quality of interpolated frames. A conventional video codec (such as H.264/AVC or H.265/HEVC) is used to compress two (or more) full-resolution (e.g., keyframes) as well as the hint frame, which are supplied together to a deep learning based VFI architecture. The information in the hint frame serves to guide the VFI process, and as a result, the ability of the deep learning based VFI architecture to correctly interpolate frames in situations of large motion, non-linear motion, and/or heavy occlusion between frames is greatly enhanced. In some embodiments, the full-resolution frames may be I-frames. For some embodiments, the full-resolution frames may P-frames and/or B-frames as well.

Significantly, the quality of interpolated frames is greatly enhanced, even in the presence of a relatively large temporal distance between the two full-resolution frames, and/or between either of the full-resolution frames and the hint frame, even in situations of large motion, non-linear motion, and/or heavy occlusion between frames. Accordingly, instead of providing the hierarchical architecture (for example, as discussed in Chao-Yuan Wu, Nayan Singhal, and Philipp Krahenbiihl, 2018, Video Compression through Image Interpolation, CoRR abs/1804.06919 (2018), arXiv:1804.06919 http://arxiv.org/abs/1804.06919, hereinafter “Wu”), and explicitly using motion or residual information, the approach discussed herein uses a low-resolution hint frame to provide additional “true” content to guide the VFI

As will be discussed herein, this approach can significantly improve interpolation results, and can thereby alleviate problems caused by deformations including occlusion, large motion and/or illumination, non-linear motion, and so on. This approach accordingly may significantly enhance adaptive streaming of video data and provides higher compression efficiency.

Various systems and methods for deep learning based interpolation of video frames are discussed and depicted herein. In some embodiments, the issues described above may be addressed by methods in which a series of input video frames is received. The series of frames may include a first frame, a second frame, and a third frame, which may be temporally located at a predetermined temporal position between the first frame and the second frame. The first frame may have a first resolution; the second frame may have a second resolution, which in various embodiments may be the same as the first resolution; and the third frame may have a third resolution, which may be lower than the first resolution (and/or the second resolution). The first frame, second frame, and third frame may be provided to a trained VFI model, which may have a deep learning architecture. With the trained VFI model, an interpolated frame may be generated at the predetermined temporal position between the first frame and the second frame, the interpolated frame having the first resolution. In this way, with the provision of the hint frame having a lower resolution than the resolution of the first frame and/or the second frame, the quality of frames interpolated from the first frame and the second frame, by the trained VFI model, may be greatly enhanced.

For some embodiments, the issues described above may be addressed by methods for interpolating specific video frames in a series. The series may include a first frame having a first temporal position of the series, a second frame having a second temporal position of the series, and an intermediate frame having an intermediate temporal position of the series between the first temporal position and the second temporal position. The first video frame and the second video frame may have a relatively higher resolution, while the intermediate frame may have a relatively lower resolution (e.g., a resolution lower than that of the first and second video frames). For interpolation, the lower-resolution intermediate frame may be upscaled to create an upscaled intermediate frame, and the first higher-resolution frame, the second higher-resolution frame, and the upscaled intermediate frame may be concatenated to produce a concatenated frame. The concatenated frame may be provided as input to a trained VFI model, and the trained VFI model may provide as output an interpolated frame having the intermediate temporal position of the series, and having the higher resolution. In this way, by providing a relatively lower-resolution intermediate frame at any arbitrary temporal position between the first video frame and the second video frame, the quality of the interpolated frame provided as output by the trained VFI model may be greatly enhanced. The VFI framework as discussed herein and depicted herein may incorporate any of a variety of deep-learning-based video frame interpolation architectures.

In some embodiments, the issues described above may be addressed by a system for interpolating video frames comprising a trained VFI model. A first full-resolution frame, a second full-resolution frame, and a lower-resolution intermediate frame may be received, the lower-resolution intermediate frame being at a temporal position between the first full-resolution frame and the second full-resolution frame. The intermediate frame may be upscaled to create an upscaled intermediate frame having the same resolution as the first full-resolution frame and the second full-resolution frame. The first full-resolution frame, the second full-resolution frame, and the upscaled intermediate frame may be concatenated into a concatenated frame. The concatenated frame may be provided to the trained VFI model, and the trained VFI model may output an interpolated frame at the temporal position of the intermediate frame, the interpolated frame having the same resolution as the first full-resolution frame and the second full-resolution frame. In various embodiments, the first full-resolution frame and/or the second full-resolution frames may be I-frames. In this way, by upscaling a lower-resolution intermediate frame, by concatenating a first full-resolution frame, the upscaled intermediate frame, and a second full-resolution frame, and by providing the concatenated frame to a trained VFI model, the quality of the interpolated frame output from the trained VFI model may be greatly enhanced. In various embodiments, the first high resolution frame and/or the second high resolution frame may be I-frames.

It should be understood that the brief description above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The disclosure may be better understood from reading the following description of non-limiting embodiments, with reference to the attached drawings, wherein below:

FIG. 1A shows a triplet of three digital video frames from a sequence of frames related to deep learning based interpolation of video frames, in accordance with one or more embodiments of the present disclosure;

FIG. 1B shows a portions of an intermediate frame related to the intermediate digital video frame of FIG. 1A, in accordance with one or more embodiments of the present disclosure;

FIG. 2 shows a top-level view of an architecture for deep learning based interpolation of video frames, in accordance with one or more embodiments of the present disclosure;

FIG. 3 shows a lower-level view of the architecture for deep learning based interpolation of video frames of FIG. 2, in accordance with one or more embodiments of the present disclosure;

FIGS. 4-5 show methods for deep learning based interpolation of video frames, in accordance with one or more embodiments of the present disclosure;

FIGS. 6 and 7 show systems for deep learning based interpolation of video frames, in accordance with one or more embodiments of the present disclosure; and

FIGS. 8A-8C show performance of methods and systems for deep learning based interpolation of video frames, as discussed and depicted herein, in accordance with one or more embodiments of the present disclosure.

### DETAILED DESCRIPTION

Deep learning based video frame interpolation (VFI) techniques may be used to generate intermediate frames between two keyframes without any explicitly encoded data except the end frames. While such techniques have made significant strides, the inventors have recognized that there are many scenarios that are still extremely difficult for deep learning based VFI techniques to handle. For example, some VFI methods focus on interpolating the pixel values of the keyframes and do not take into account other information, such as depth or texture. This approach makes the generated frame look artificial and tends to generate inaccurate results. Some VFI methods rely heavily on flow and depth information to create accurate and realistic interpolated frames, which may be less practical, since that can be computationally expensive and may not be suitable for all types of video content or devices.

Various deep learning alternatives to DCT-based coding use one or more convolutional neural networks (CNNs) to design an auto-encoder, or one or more recurrent neural networks (RNNs) to build progressive image compression schemes. However, deep learning based compression methods might not have built-in error resilience mechanisms for fault tolerance which may be present in traditional codecs (such as headers and/or resynchronization markers). As a result, errors and/or failures in the data may be more likely to result in loss of information or errors in the output.

Some approaches to applying deep learning techniques to video compression have focused on end-to-end codecs that explore the capacity of deep neural networks to achieve high compression rates. In some approaches e.g., as discussed in Wu, frame interpolation may be used to generate intermediate frames. A major limitation of such interpolation based approaches is that the quality of frames generated through simple interpolation diminishes as the temporal distance between video keyframes increases, particularly for video sequences that reflect non-linear movement such as rotation or perspective changes. Some approaches may use ground truth motion and residual encoding to disambiguate the interpolation.

Other approaches employ interpolation of intermediate frames and attempt to identify and transmit macroblocks that do not match within some peak signal-to-noise ratio (PSNR) threshold per macroblock. A drawback of such approaches may be that they combine both DCT-coding and frame interpolation on a macroblock-by-macroblock basis, in effect mixing two styles of frames. As a result, the interpolation and the explicit fix have to be extremely well aligned, or the deep learning framework will be left to resolve the mismatch.

Accordingly, although VFI techniques have been proposed as a way to skip encoding various frames and to instead generate those frames from surrounding frames, current deep learning based methods do not fully replace standard and/or traditional video codecs like the H.26x series of compression standards (e.g., the H.264 Advanced Video Coding (AVC) standard, the H.265 High Efficiency Video Coding (HEVC) standard, and so on). Moreover, there is currently no widely accepted standard for deep learning based video compression, which can make it difficult to ensure interoperability, and even to compare different methods.

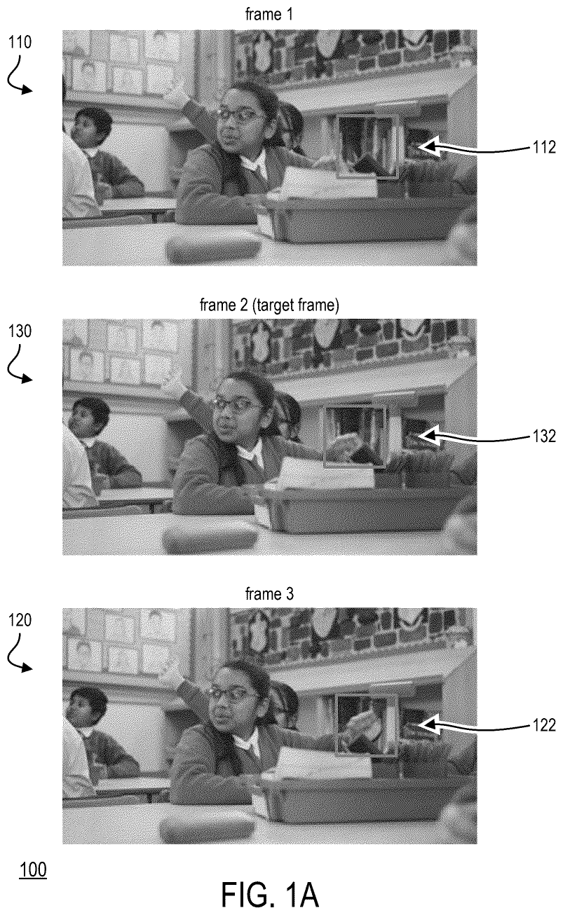

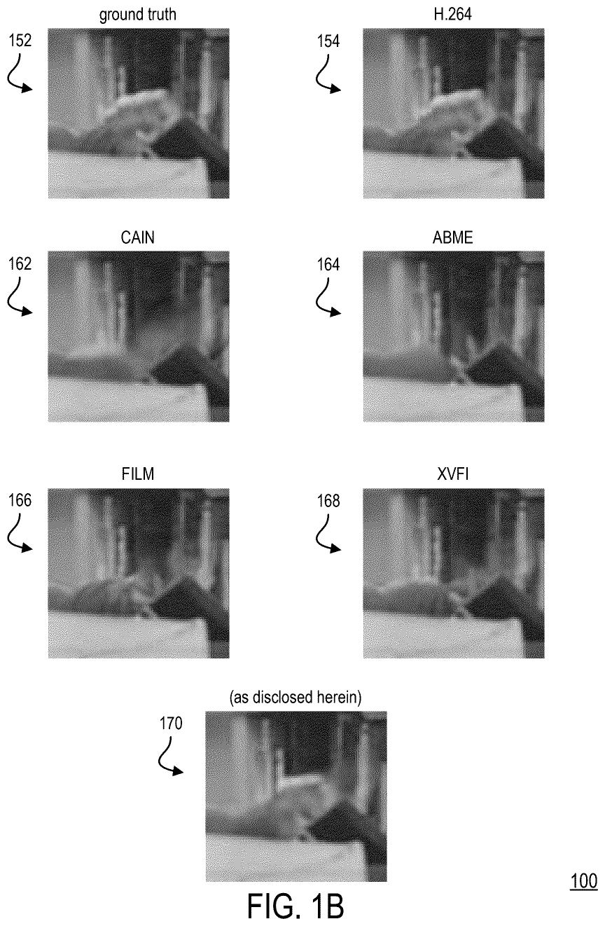

Disclosed herein are various systems and methods for deep learning based interpolation of video frames. Groups of images from digital video sequences may include a first high resolution frame or keyframe, a second high resolution frame or keyframe, and an intermediate frames (which may be from a temporal position between the first high resolution frame and second high resolution frame), as depicted in FIGS. 1A and 1B. A lower-resolution version of the intermediate frame may be created, and in some embodiments, one or more of the first high resolution frame, the second high resolution frame, and the intermediate frame may be compressed (e.g., by a conventional compression codec). Following potential compression, the first high resolution frame, the low-resolution intermediate frame, and the second I frame may be transmitted and/or stored (e.g., by a first device), and later received and/or accessed (e.g., by a second device). In various embodiments, in the methods and systems discussed and depicted herein, high resolution frames may be full-resolution frames such as I-frames (which may improve a quality of interpolation), although they may also be other full-resolution frames (such as B-frames and/or P-frames). For various embodiments, the first high resolution frame, the second high resolution frame, and the intermediate frame may be part of a sequence of high resolution frames, and the intermediate frame may be one of a plurality of lower-resolution intermediate frames from temporal positions between the first high resolution frame and the second high resolution frame. In some embodiments, the high resolution frames can all be I-frames, or frames generated in accordance with a video-compression standard, and some portion of the frames may be partially derived using recursive application of, e.g., a video codec and/or a VIF technique.

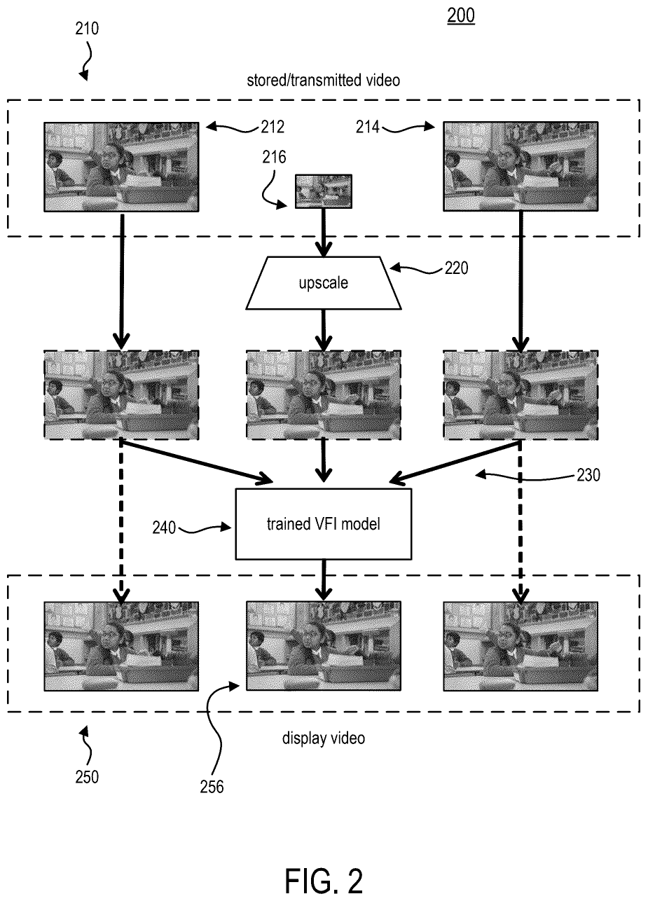

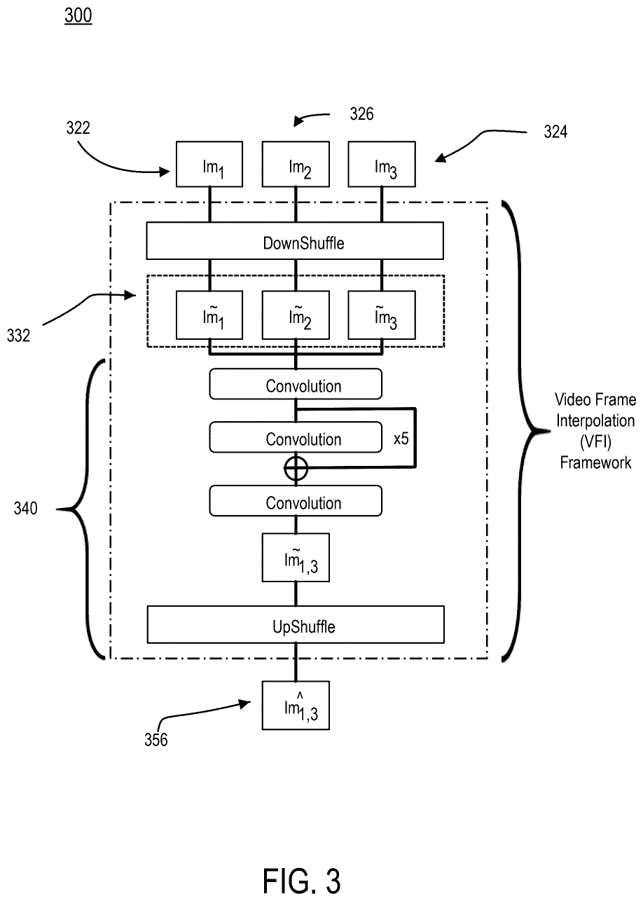

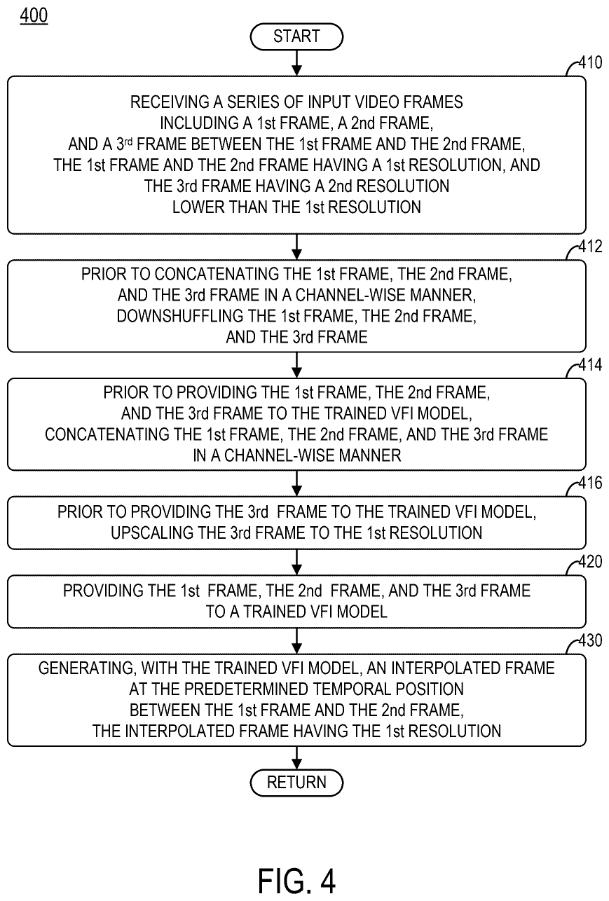

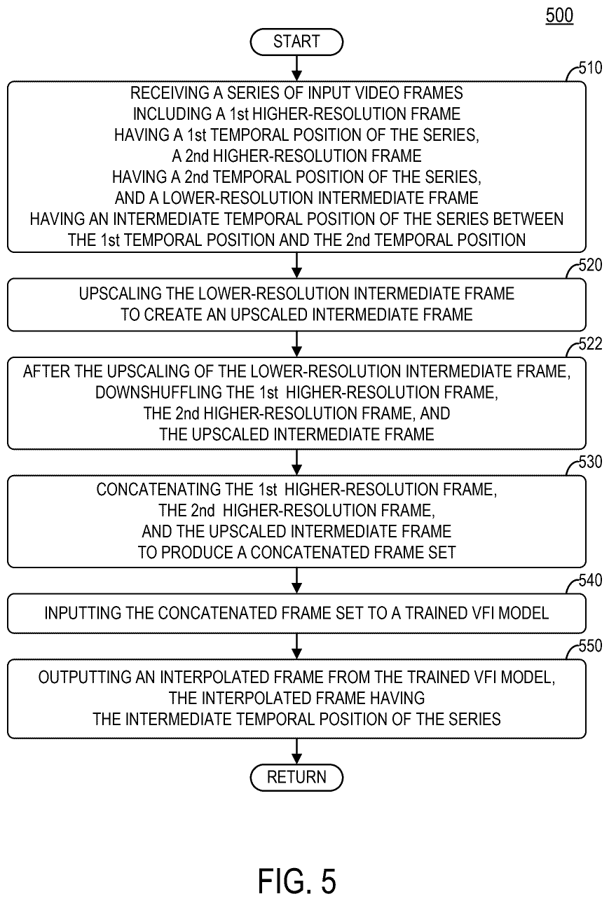

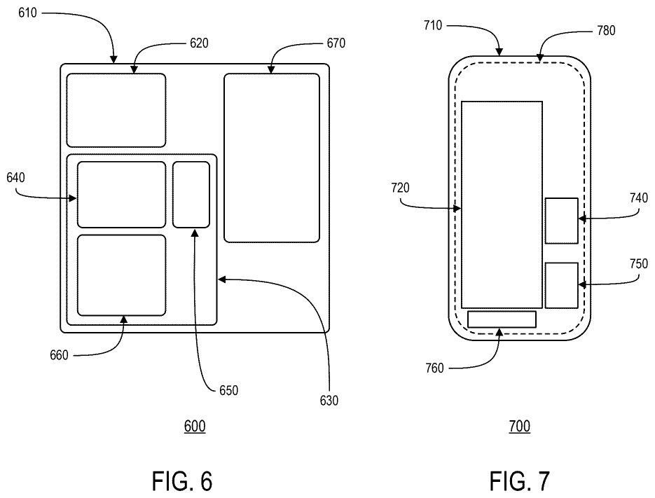

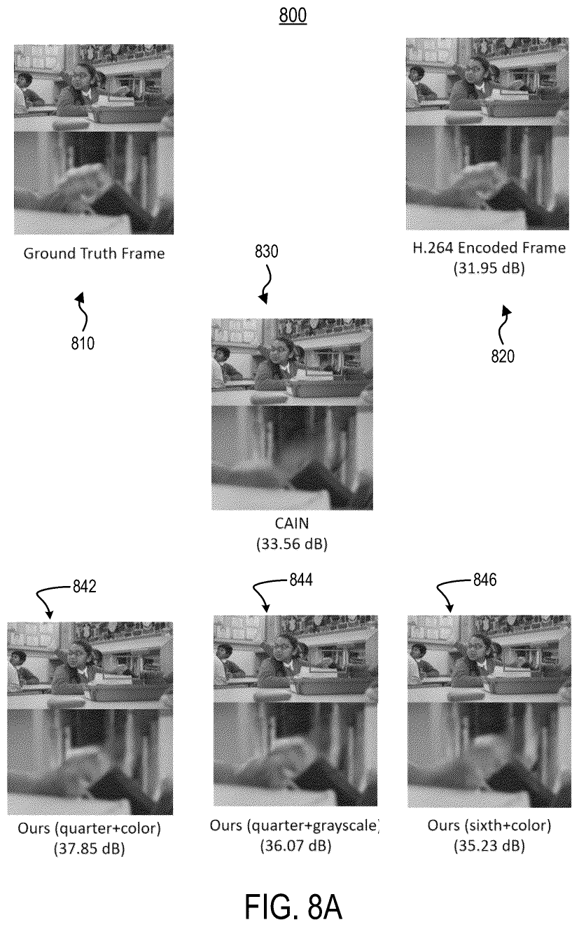

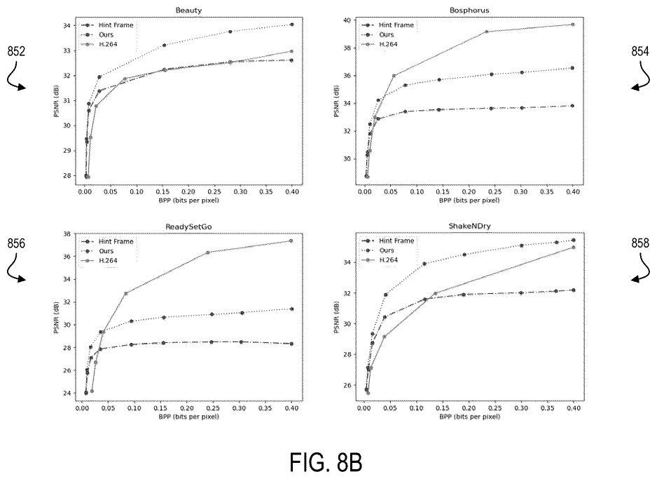

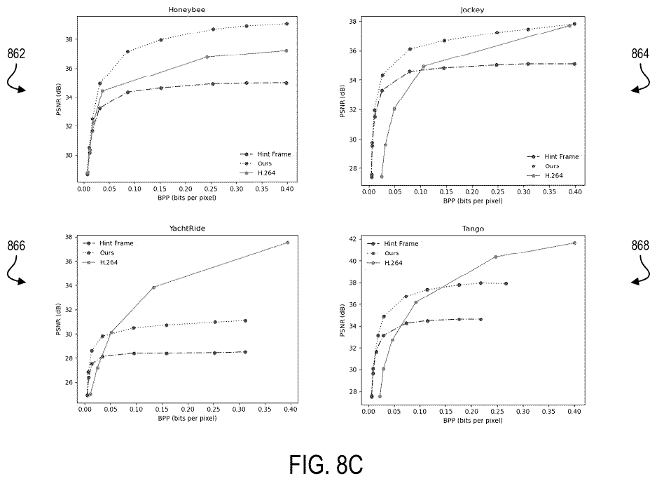

As depicted in FIGS. 2 and 3, and as addressed by the methods of FIGS. 4 and 5, the low-resolution intermediate frame may be upscaled and/or upsampled, and within a VFI framework as disclosed herein, the first high resolution frame, the upscaled intermediate frame, and the second high resolution frame may be concatenated (e.g., into a concatenated frame) and presented to a trained VFI model. The trained VFI model may then make use of the first high resolution frame, the second high resolution frame, and the upscaled intermediate frame—which contains “hints” about, e.g., movement and occlusion of various elements in the images—to interpolate (e.g., predict) an intermediate frame. FIGS. 6 and 7 depict some systems that might carry out these methods. Finally, FIGS. 8A-8C depict results based on the systems and methods disclosed herein.

FIG. 1A shows a triplet of three digital video frames from a sequence of frames related to deep learning based interpolation of video frames. A sequence of digital video frames 100 may comprise a first frame 110, a second frame 120, and an intermediate frame 130, which may occupy a temporal position between first frame 110 and second frame 120. In various embodiments, first frame 110 and second frame 120 may be “keyframes” for use in digital image compression and/or digital video compression, and may thereafter be associated with high-resolution frames of a compressed sequence of digital video frames (which may be I-frames, which may in turn increase a quality of interpolation). First frame 110, second frame 120, and intermediate frame 130 may be used to create digital video frames that may be used by a trained VFI to generate an interpolated frame that can replace intermediate frame 130. Accordingly, a relatively high-quality representation of the sequence of frames associated with first frame 110, second frame 120, and intermediate frame 130 may be transmitted by transmitting merely encoded versions of first frame 110, second frame 120, and a lower-resolution version of intermediate frame 130.

An image triplet for use in the systems and methods disclosed herein may include first frame 110, second frame 120, and intermediate frame 130. For this image triplet, there is an area of each of these frames that may present challenges for other deep learning based VFI techniques. With respect to a first area 112 of first frame 110, a second area 122 of second frame 120, and an intermediate area 132 of intermediate frame 130, a hand of a subject of the images is largely hidden from view in first frame 110 (e.g., occluded), but is no longer hidden from view by the time of second frame 120. As discussed below, other deep learning based VFI techniques cannot correctly generate an interpolated version of intermediate area 132 of intermediate frame 130, and therefore cannot generate a high-quality interpolated version of intermediate frame 130 as a whole.

FIG. 1B is a comparison of different video frame interpolations of an intermediate frame related to the intermediate digital video frame of FIG. 1A. As depicted in FIG. 1B, an area 152 (labeled “ground truth”) shows the contents of intermediate area 132 in their true state. For comparison, an area 154 shows the contents of intermediate area 132 following encoding (here, by the H.264 codec, although other codecs may be used in various embodiments). As may be seen, the encoded contents of intermediate area 132 represented by area 154 closely match the ground truth of intermediate area 132 represented by area 152. That is, the hand of the subject of first frame 110 and second frame 120 is clearly represented in area 154, following encoding.

An area 162, an area 164, an area 166, and an area 168 each show the contents of intermediate area 132 as interpolated (e.g., as predicted) by a variety of VFI techniques. Area 162 shows the contents of intermediate area 132 as interpolated by a “Channel Attention for frame Interpolation” (CAIN) VFI technique (as discussed in Myungsub Choi, Heewon Kim, Bohyung Han, Ning Xu, and Kyoung Mu Lee, 2020, Channel Attention Is All You Need for Video Frame Interpolation, Proceedings of the AAAI Conference on Artificial Intelligence 34, 07 (April 2020), 10663-10671, https://doi.org/10.1609/aaai.v34i07.6693, which is herein incorporated by reference in its entirety). Area 164 shows the contents of intermediate area 132 as interpolated by an “Asymmetric Bilateral Motion Estimation” (ABME) VFI technique (as discussed in J. Park, C. Lee, and C. Kim, 2021, Asymmetric Bilateral Motion Estimation for Video Frame Interpolation, In International Conference on Computer Vision). Area 166 shows the contents of intermediate area 132 as interpolated by a “Frame Interpolation with Large Motion” (FILM) VFI technique (as discussed in Myungsub Choi, Heewon Kim, Bohyung Han, Ning Xu, and Kyoung Mu Lee, 2020, Channel Attention Is All You Need for Video Frame Interpolation, Proceedings of the AAAI Conference on Artificial Intelligence 34, 07 (April 2020), 10663-10671, https://doi.org/10.1609/aaai.v34i07.6693). Area 168 shows the contents of intermediate area 132 as interpolated by an “eXtreme Video Frame Interpolation” (XVFI) VFI technique (as discussed in H. Sim, J. Oh, and M. Kim. 2021, XVFI: eXtreme Video Frame Interpolation, In Proceedings of the IEEE International Conference on Computer Vision (ICCV)).

As may be seen, the interpolated contents of intermediate area represented by area 162 (for a CAIN technique), area 164 (for an ABME technique), area 166 (for a FILM technique), and area 168 (for an XVFI technique) fail to accurately capture the hand motion of the underlying sequence of video frames that is captured at least in part by intermediate area 132, because the hand of the subject of first frame 110 and second frame 120 is almost entirely absent in area 162, area 164, area 166, and area 168.

In comparison with these, an area 170 shows the contents of intermediate area 132 as interpolated by the VFI methods and/or systems disclosed herein. The interpolated contents of intermediate area 132 represented by area 170 are not as close a match as area 154 is to the ground truth of intermediate area 132 represented by area 152. However, as may be seen, the hand of the subject of first frame 110 and second frame 120 is captured and represented in area 170. Accordingly, the interpolated contents of intermediate area 132 represented by area 170 is of a significantly higher quality than the interpolated contents of intermediate area 132 represented by area 162, area 164, area 166, and area 168.

With the hand being hidden from view in first frame 110, the CAIN, ABME, FILM, and XVFI techniques are unable to estimate the motion of the hand correctly when interpolating intermediate frame 130. Since situations of large motion, non-linear motion, and/or heavy occlusion between frames can occur in complex and varied ways, making any interpolation based technique work well across different types of image sequences becomes extremely difficult. Other approaches may use context, depth, flow, and/or edges to solve these problems, but such approaches lead to more processing steps, which in turn leads to the use of more computation.

Accordingly, there are some sequences that may be extremely difficult for deep learning based approaches to efficiently interpolate. The methods and systems disclosed herein advantageously may use low-resolutions versions of intermediate frames to help the guide deep learning based VFI, thereby taking advantage of a decreased number of bits for transmission while increasing the quality of the resulting interpolated frames. Moreover, the methods and systems disclosed herein may advantageously use standards based (e.g., DCT-based) coding algorithms to preserve high visual quality while decreasing the bits for transmission even further.

In accordance with the methods and systems disclosed herein, a lower-resolution version of intermediate frame 130 may be generated (or a resolution of intermediate frame 130 may be otherwise reduced), and a sequence of video frames including first frame 110, second frame 120, and the lower-resolution version intermediate frame 130 may be compressed (e.g., in compliance with H.26x compression standard, such as the H.264/AVC standard or the H.265/HEVC standard). The compressed sequence of video frames may be transmitted and/or stored (e.g., by a first device), then received and/or accessed (e.g., by a second device).

As discussed further below, upon being received (and/or accessed), in accordance with a VFI framework as disclosed herein, an upscaled version of intermediate frame 130 may be generated (or the lower-resolution version of intermediate frame 130 may be otherwise upscaled), and first frame 110, second frame 120, and the upscaled version of intermediate frame 130 may be concatenated and provided to a trained VFI model. The trained VFI model may then output an interpolated version of intermediate frame 130.

FIG. 2 shows a top-level view of an architecture for deep learning based interpolation of video frames. A deep learning based VFI architecture 200 may comprise an input stage 210, an upscaling stage 220, a VFI framework having a concatenation stage 230 and a VFI model stage 240, and an output stage 250.

At input stage 210, VFI architecture 200 may receive and/or access a first frame 212, a second frame 214, and a third frame 216 of a sequence of video frames. First frame 212 may be a first high resolution frame or first keyframe of the sequence, second frame 214 may be a second I-frame or second keyframe of the sequence, and third frame 216 may be an intermediate frame of the sequence, for which there may be multiple intermediate frames (with only one intermediate frame being depicted), and may be at a temporal position between a temporal position of first frame 212 and a temporal position of second frame 214. In various embodiments, the first high resolution frame and/or the second high resolution frame may be I-frames. Accordingly, first frame 212 may be substantially similar to first frame 110, second frame 214 may be substantially similar to second frame 120, and third frame 216 may be substantially similar to intermediate frame 130 (as discussed herein). In addition, as depicted, third frame 216 is at a lower resolution than a resolution of first frame 212 and second frame 214. Accordingly, for various embodiments, first frame 212 and second frame 214 may be full-resolution frames (e.g., high resolution frames and/or keyframes), and third frame 216 may be a significantly low-resolution frame (e.g., a frame having a resolution significantly lower than full resolution).

In some embodiments, third frame 216 (e.g., as received and/or accessed by input stage 210) may be a downsampled frame. The downsampling of the frame may use bicubic sampling and/or may otherwise estimate values between two points using a cubic function. In various embodiments, third frame 216 may be downsampled with a bicubic downsampling using a weighted average of 4×4 blocks to determine pixels. A bicubic algorithm may advantageously preserve details more usefully in comparison with other downsampling methods (e.g., handcrafted downsampling methods).

An advantage of hint frames as disclosed herein is that they may explicitly provide a low-resolution approximation of the real frame, which may have the capacity to provide information regarding a wide variety of types of motion and/or context as hints to the trained VFI model on the decoder side, rather than leaving the VFI model to guess. Hint frames may thus give extra guidance to a trained VFI model regarding large non-linear motions and rotations, which may be otherwise challenging to handle. This may advantageously help the interpolation model in locating pixels in intermediate frames associated with, e.g., motion of depicted subjects.

In various embodiments, first frame 212, second frame 214, and/or third frame 216 (e.g., following downsampling), as received and/or accessed by input stage 210, may be compressed. In some embodiments, first frame 212, second frame 214, and third frame 216 may be compressed in accordance with a compression standard from the H.26x series of compression standards (e.g., the H.264/AVC standard or the H.265/HEVC standard).

As I-frames of an H.26x video coding standard, first frame 212 and second frame 214 may be a type of frame that provides a reference for intermediate frames in order to minimize and/or prevent error propagation in the context of the coding standard. The deep learning based VFI methods and systems discussed herein may advantageously redirect this property of I-frames in the context of H26x coding standards to aid in interpolating third frame 216 and/or other frames between first frame 212 and second frame 214.

In various embodiments, an encoding command used to encode first frame 212, second frame 214, and/or third frame 216 may use Quantization Parameter (QP) instead of Constant Rate Factor (CRF). Since QP uses a fixed set of quantization levels and a limited number of bits to represent the video, the use of QP may advantageously result in lower file sizes and/or faster encoding times. The use of QP may also result in a less complex algorithm to model the probability of a particular image configuration, which may advantageously be less computationally expensive. The use of QP may also avoid adaptive alteration of coding quantization parameters on the fly, and may advantageously simplify the consistent measurement of quality metrics such as PSNR. For some embodiments, the encoding command may use QP parameters 5, 10, 14, 18, 23, 27, 31, and/or 40. In various embodiments, the encoding command may use any QP parameters (with lower QP parameters corresponding with higher quality encoding and more bits to represent it, and supporting higher quality interpolation, and with higher QP parameters corresponding with lower quality encoding and fewer bits to represent it, but supporting poorer quality interpolation).

At upscaling stage 220, following receipt and/or access of first frame 212, second frame 214, and third frame 216 at input stage 210, third frame 216 may be upscaled to the same resolution as a resolution of first frame 212 and/or second frame 214. In some embodiments, the upsampling may use pixel replication, which may advantageously avoid dependence upon the upsampling interpolation method. For some embodiments, the upscaling may use parameter-free bicubic resampling to resample third frame 216 to a desired resolution (e.g., to a resolution of first frame 212 and/or second frame 214), which may advantageously enable and/or facilitate transmission of fewer parameters.

Within the VFI framework, at concatenation stage 230, first frame 212, an upscaled third frame 216, and second frame 214 may be concatenated. The concatenated frame (e.g., the concatenation of first frame 212, upscaled third frame 216, and second frame 214) may be provided to VFI model stage 240 of the VFI framework.

A VFI model of VFI model stage 240 may generate an interpolated frame 256, at the same resolution as first frame 212 and second frame 214 (e.g., a full-resolution frame). Interpolated frame 256 may accordingly represent a prediction made by architecture 200 of the frame used in generating third frame 216 of input stage 210. Output stage 250 may include first frame 212, interpolated frame 256, and second frame 214.

Thus, in various embodiments, first frame 212 and second frame 214 may be provided at input stage 210 for each of a set of hint frames provided in the place of third frame 216. For each of the hint frames, VFI architecture 200 may produce a corresponding interpolated frame in the place of interpolated frame 256.

Other VFI architectures that have been proposed for video compression have used separate VFI models each of which is trained to different temporal distances between the frame to be interpolated and the two frames being used for the interpolation. In contrast, VFI architecture 200 is fixed, and the VFI model of VFI model stage 240 may trained to interpolates frames without respect to the temporal distance between the frame being interpolated and the keyframes being used for the interpolation. Thus, when the VFI model of VFI model stage 240 is presented with concatenated frames (as discussed further below) incorporating keyframes and intermediate frames at any of a variety of different temporal distances from the keyframes, the VFI model may interpolate (e.g., predict) intermediate frames based on hint frames at the same variety of different temporal distances from corresponding keyframes.

Accordingly, VFI architecture 200 may advantageously accommodate the saving and transmission of fewer parameters in the course of supporting the compression and decompression involved, since the trained VFI model of VFI model stage 240 can interpolate based on hint frames regardless of temporal distances associated with those hint frames. Moreover, the trained VFI model may directly interpolate frames at a variety of temporal distances from corresponding keyframes, and therefore may advantageously avoid recursive interpolation of frames (which may propagate errors among frames).

FIG. 3 shows a lower-level view of the architecture for deep learning based interpolation of video frames of FIG. 2. A VFI architecture portion 300 may receive a first frame 322, a second frame 324, and an upscaled third frame 326 (e.g., following an upscaling stage, which may be substantially similar to upscaling stage 220). VFI architecture portion 300 may be similar to portions of a VFI architecture in accordance with a CAIN VFI technique.

In VFI architecture portion 300, first frame 322, second frame 324, and upscaled third frame 326 may be downshuffled in accordance with a “PixelShuffle” technique, e.g., for periodic shuffling and/or rearrangement of the elements of a tensor (as discussed in Wenzhe Shi, Jose Caballero, Ferenc Huszir, Johannes Totz, Andrew P. Aitken, Rob Bishop, Daniel Rueckert, and Zehan Wang, 2016, Real-Time Single Image and Video Super-Resolution Using an Efficient Sub-Pixel Convolutional Neural Network, CoRR abs/1609.05158 (2016), arXiv:1609.05158). The downshuffled version of first frame 322, the downshuffled version of upscaled third frame 326, and the downshuffled version of second frame 324 may be concatenated, such as by a channel-wise concatenation. The concatenated frame may be provided to a trained VFI model 340 (which may be substantially similar to a trained VFI model of VFI model stage 240), which may apply various residual blocks with channel attention (e.g., in accordance with a CAIN VFI technique). The hint frames may advantageously be provided to the channel attention to interpolate high-quality intermediate frames (e.g., by handling situations of large motion, non-linear motion, and/or heavy occlusion between frames), such as interpolated frame 356, without obtaining explicit motion information (e.g., by explicitly estimating the flow).

A first difference between VFI architecture portion 300 and a CAIN VFI technique is that instead of receiving merely first frame 322 and second frame 324, VFI architecture portion 300 also receives upscaled third frame 326, e.g., a hint frame as discussed herein. A second difference is that following the downshuffling, instead of performing a channel-wise concatenation on merely the downshuffled version of first frame 322 and the downshuffled version of second frame 324, VFI architecture portion performs a channel-wise concatenation on the downshuffled version of first frame 322, the downshuffled version of upscaled third frame 326, and the downshuffled version of second frame 324. As a result of these differences, as discussed herein, VFI architecture portion 300 may advantageously generate significantly higher-quality interpolated frames than other VFI techniques, including CAIN VFI techniques.

Accordingly, in various embodiments, systems for interpolating video frames may comprise trained VFI models (such as a trained VFI model of model stage 240 and/or a trained VFI model 340), one or more processors, and a non-transitory memory having executable instructions which, when executed, may cause the one or more processors to perform various operations, as discussed below. A first high resolution frame (such as first frame 322), a second high resolution frame (such as second frame 324), and a lower-resolution intermediate frame at a temporal position between the first high resolution frame and the second high resolution frame may be received. The intermediate frame may be upscaled to create an upscaled intermediate frame (such as third frame 326) having the same resolution as the first high resolution frame and the second high resolution frame. The first high resolution frame, the second high resolution frame, and the upscaled intermediate frame may be concatenated into a concatenated frame, and the concatenated frame may be provided to the trained VFI model. The trained VFI model may output an interpolated frame (such interpolated frame 356) as at the temporal position, the interpolated frame having the same resolution as the first high resolution frame and the second high resolution frame. In various embodiments, the first high resolution frame and/or the second high resolution frame may be keyframes and/or full-resolution frames (such as I-frames).

In some embodiments, the first high resolution frame, the second high resolution frame, and the intermediate frame may be compressed in compliance with an H.26x video compression standard, such as the H.264/AVC standard, or the H.265/HEVC standard. In various embodiments, the first high resolution frame and/or the second high resolution frame may be fully encoded frames and/or may be compressed (e.g., in compliance with an H.26x video compression standard). For some embodiments, the upscaling of the intermediate hint frame may be via pixel replication. In some embodiments, the concatenating of the first high resolution frame, the second high resolution frame, and the upscaled intermediate frame may be in a channel-wise manner. In some embodiments, prior to the concatenation of the first high resolution frame, the second high resolution frame, and the upscaled intermediate frame, the first high resolution frame, the second high resolution frame, and the upscaled intermediate frame may be downshuffled.

FIGS. 4-5 show methods for deep learning based interpolation of video frames. As depicted in FIG. 4, a method 400 may comprise the steps of receiving an input 410, providing the images to a model 420, and generating an interpolated frame 430. In various embodiments, method 400 may also comprise the steps of downshuffling the frames 412, concatenating the frames 414, and/or upscaling the third frame 416. In various embodiments, method 400 may employ some or all of these steps, in any order.

At 410, a series of input video frames may be received. The series of input video frames may include a first frame, a second frame, and a third frame at a predetermined temporal position between the first frame and the second frame. The first frame and the second frame may have a first resolution, and the third frame may have a second resolution lower than the first resolution. At 420, the first frame, the second frame, and the third frame may be provided to a trained VFI model. At 430, an interpolated frame may be generated, with the trained VFI model, at the predetermined temporal position between the first frame and the second frame, the interpolated frame having the first resolution.

In some embodiments, the first frame, the second frame, and the third frame may be compressed. For some embodiments, the first frame, the second frame, and/or the third frame may be compressed in compliance with an H.26x video compression standard. The second resolution may be less than the first resolution, e.g., to trade-off bit rate and quality. For some embodiments, the second resolution may be no more than ¼ the size of the first resolution along both an X-axis and a Y-axis. In other embodiments, the second resolution may be between ¼ to ½ the size of the first resolution along both an X-axis and a Y-axis. In various embodiments, the second resolution may be between ¼ and ⅙ the size of the first resolution along both an X-axis and a Y-axis.

In some embodiments, at 416, prior to providing the third frame to the trained VFI model, the third frame may be upscaled to the first resolution. For some embodiments, the hint frame may be upscaled via pixel replication. For some embodiments, at 414, prior to providing the first frame, the second frame, and the third frame to the trained VFI model, the first frame, the second frame, and the third frame may be concatenated in a channel-wise manner. In some embodiments, in downshuffling 412, prior to concatenating the first frame, the second frame, and the third frame in a channel-wise manner, the first frame, the second frame, and the third frame may be downshuffled.

For some embodiments, an indicator to disable the use of the lower resolution third frame may be received along with the first frame, the second frame, and/or the third frame. The indicator may have a first predetermined value representing disabling the use of the third frame and a second predetermined value representing enabling the use of the third frame. The provision of the first frame, the second frame, and the third frame to the trained VFI model may occur based upon a value of the indicator matching the second predetermined value; if the value of the indicator matches the first predetermined value instead, then the mere provision of the first frame and the second frame to the trained VFI model may occur.

A method 500 may comprise receiving input 510, upscaling frames 520, concatenating frames 530, inputting the frames 540, and outputting an interpolated frame 550. In various embodiments, method 500 may also comprise a downshuffling of the frames 522. In various embodiments, method 500 may employ some or all of these steps, in any order.

At 510, a series of input video frames may be received (e.g., by a device and/or system implementing a deep-learning VFI technique as disclosed herein), the series of input video frames including a first higher-resolution frame having a first temporal position of the series, a second higher-resolution frame having a second temporal position of the series, and a lower-resolution intermediate frame having an intermediate temporal position of the series between the first temporal position and the second temporal position. At 520, the lower-resolution intermediate frame may be upscaled to create an upscaled intermediate frame. At 530, the first higher-resolution frame, the second higher-resolution frame, and the upscaled intermediate frame may be concatenated to produce a concatenated frame. In inputting 540, the concatenated frame may be inputted to a trained VFI model. At 550, an interpolated frame may be outputted from the trained VFI model, the interpolated frame having the intermediate temporal position of the series.

The second resolution may be less than the first resolution, e.g., to trade-off bit rate and quality. In some embodiments, the second resolution may be no more than ¼ the size of the first resolution along both an X-axis and a Y-axis. In other embodiments, the second resolution may be between ¼ to ½ the size of the first resolution along both an X-axis and a Y-axis. For some embodiments, a resolution of the first higher-resolution frame, a resolution of the second higher-resolution frame, and a resolution of the lower-resolution intermediate frame are the same. In other embodiments, one or more of the frames is at a different resolution than another frame. In some embodiments, the upscaling of the lower-resolution intermediate frame may be via pixel replication. For some embodiments, the concatenation of the first higher-resolution frame, the second higher-resolution frame, and the upscaled intermediate frame may be in a channel-wise manner. In some embodiments, in downshuffling 522, after the upscaling of the lower-resolution intermediate frame, the first higher-resolution frame, the second higher-resolution frame, and the upscaled intermediate frame may be downshuffled.

The methods may be configured for the operation of the systems disclosed herein. Thus, the same advantages that apply to the systems may apply to the methods.

The description of embodiments has been presented for purposes of illustration and description. Suitable modifications and variations to the embodiments may be performed in light of the above description or may be acquired from practicing the methods. For example, unless otherwise noted, one or more of the described methods may be performed by a suitable device and/or combination of devices. The methods may be performed by executing stored instructions with one or more logic devices (e.g., processors) in combination with one or more additional hardware elements, such as storage devices, memory, image sensors/lens systems, light sensors, hardware network interfaces/antennas, switches, actuators, clock circuits, and so on. The described methods and associated actions may also be performed in various orders in addition to the order described in this application, in parallel, and/or simultaneously.

FIGS. 6 and 7 show systems for deep learning based interpolation of video frames. FIG. 6 shows a system 600, which may comprise a case 610, a power source 620, an interconnection board 630, one or more processors 640, one or more memory devices 650, one or more input/output (I/O) interfaces 660, and/or one or more media drives 670.

Case 610 may be any type of enclosure for portions of system 600. In some embodiments, case 610 may have a form suitable for use as a case for a personal computer (e.g., a desktop computer). In other embodiments, case 610 may have a form suitable for insertion into a rack of components (e.g., a server blade).

Various processors included in processors 640 may have one or more Central Processing Units (CPUs) and/or microprocessors. Each of the CPUs and/or microprocessors may in turn have any number of processing cores, and each core may be operable to process one or more threads at a time. In various embodiments, the CPUs and/or microprocessors may include any of a Digital Signal Processor (DSP), a Graphics Processing Unit (GPU), a network processor, and/or other special-purpose processors, coprocessors, or units.

Memory devices 650 may include devices based upon any of a variety of storage technologies. In various embodiments, memory devices 650 may include magnetic-disk-based storage and/or optical-disk-based storage. Memory devices 650 may also include various types of Random Access Memory (RAM) based storage, such as Dynamic RAM (DRAM) based storage. In some embodiments, memory devices 650 may include non-volatile memory, such as flash memory, or phase-change memory (PCM). Media drives 670 may also include devices based on, for example, magnetic-disk-based storage technologies and/or optical-disk-based storage technologies. Memory devices 650 may have executable instructions stored therein that, when executed, cause processors 640 to perform various operations, as disclosed herein (e.g., with respect to method 400, method 500, the VFI architectures of FIGS. 2 and 3, and/or any of the various methods and systems disclosed herein).

I/O interfaces 660 may include electronic interfaces operable to be communicatively coupled to I/O devices, using electronics developed for various I/O technologies (e.g., bus specifications, interconnect specifications, and the like). I/O interfaces may include propriety interconnect configurations, as well as interfaces complying with, e.g., a Universal Serial Bus (USB) protocol, a Serial Advanced-Technology Attachment (SATA) bus protocol, a Peripheral Component Interconnect (PCI) Express protocol, and the like. Some I/O interfaces 660 may connect components within system 600 to each other, while other I/O interfaces 660 may connect components within system 600 to other devices external to system 600. I/O interfaces 660 may also include one or more wired internet connections (e.g., Ethernet connections) and/or one or more interfaces for wireless connections (e.g., Wi-Fi and/or cellular connections).

Power source 620 may be operable to provide electrical power to processors 640, memory devices 650, I/O interfaces 660, end/or media drives 670. Meanwhile, interconnection board 630 may electrically and/or electronically couple power source 620, processors 640, memory devices 650, I/O interfaces 660, and/or media drives 670. Interconnection board 630 may, for example, include a motherboard, or other printed circuitry board (PCB) used for providing power to and/or interconnecting various electronic devices.

System 600 (and/or other systems and devices disclosed herein) may be configured in accordance with the systems discussed herein. For example, system 600 may implement a VFI architecture substantially similar to the VFI architectures of FIG. 2 or FIG. 3, and/or may undertake a method substantially similar to method 400 and/or method 500. Thus, the same advantages as discussed herein that apply to the VFI architectures of FIGS. 2 and 3, and/or to method 400 and/or method 500, may apply to system 600.

FIG. 7 shows a system 700, which may comprise a case 710, a power source 720, one or more processors 740, one or more memory devices 750, one or more antennas 760, and/or a display screen 780.

Case 710 may be any type of enclosure for portions of system 700. In some embodiments, case 710 may have a form suitable for use as a case for a smart device such as a tablet or a smart phone.

Various processors included in processors 740 may have one or more CPUs and/or microprocessors. Each of the CPUs and/or microprocessors may in turn have any number of processing cores, and each core may be operable to process one or more threads at a time. In various embodiments, the CPUs and/or microprocessors may include any of a DSP, a GPU, a network processor, and/or other special-purpose processors, coprocessors, or units.

Memory devices 750 may include devices based upon any of a variety of storage technologies. In various embodiments, memory devices 750 may include non-volatile memory, such as flash memory, or PCM. Memory devices 750 may have executable instructions stored therein that, when executed, cause processors 740 to perform various operations, as disclosed herein. Memory devices 750 may have executable instructions stored therein that, when executed, cause processors 740 to perform various operations, as disclosed herein (e.g., with respect to method 400, method 500, the VFI architectures of FIGS. 2 and 3, and/or any of the various methods and systems disclosed herein).

I/O interfaces 760 may include electronic interfaces operable to be communicatively coupled to I/O devices, using electronics developed for various I/O technologies (e.g., bus specifications, interconnect specifications, and the like). I/O interfaces may include propriety interconnect configurations, as well as interfaces complying with, e.g., a USB protocol or the like. I/O interfaces 760 may also include one or more interfaces for wireless connections (e.g., Wi-Fi and/or cellular connections). Power source 720 may be operable to provide electrical power to processors 740, memory devices 750, I/O interfaces 760, end/or media drives 770.

System 700 (and/or other systems and devices disclosed herein) may be configured in accordance with the systems discussed herein. For example, system 700 may implement a VFI architecture substantially similar to the VFI architectures of FIG. 2 or FIG. 3, and/or may undertake a method substantially similar to method 400 and/or method 500. Thus, the same advantages as discussed herein that apply to the VFI architectures of FGS. 2 and 3, and/or to method 400 and/or method 500, may apply to system 700.

FIGS. 8A-8C show performance of methods and systems for deep learning based interpolation of video frames, as discussed and depicted herein. A data set 800 includes a ground truth 810, an encoding 820 (e.g., an H.26x encoding), a CAIN VFI 830, a first VFI 842, a second VFI 844, and a third VFI 846. With respect to data set 800, CAIN VFI 830, first VFI 842, second VFI 844, and third VFI 846 were trained using a training set of over 50,000 video frame triplets (e.g., three frames of digital video), with resolutions of 448×256. Following training, the various VFI models were tested against various video frame triplets from a testing set associated with the training set.

A group of pictures (GOP) size was set to 16. For a GOP size of 16, a first frame of the GOP, as well as a first frame of the next GOP, served as the two high resolution frame (or keyframes, such as I-frames). Accordingly, adjacent GOPs share the same boundary high resolution frame (or keyframe). Each GOP was processed independently. Different GOP sizes were tested (e.g., GOP sizes of 2 through 12), and a quality of reconstructed frame results (e.g., interpolated frames) was fairly consistent. In order to reduce bits used, a GOP size of 12 was chosen

With respect to frame interpolation, Table 1 presents data regarding PSNR and Structural Similarity Index Measure (SSIM) for CAIN VFI 830 (“CAIN (baseline)”), first VFI 842 (“+¼ color”), second VFI 844 (“+¼ grayscale”), and third VFI 846 (“+⅙ color”).

TABLE 1
Frame interpolation comparison of using different VFIs.

| | PSNR | SSIM |
|---|---|---|
| CAIN (baseline) | 34.65 dB | 0.9730 |
| +¼ color | 36.82 dB | 0.9784 |
| +¼ grayscale | 35.62 dB | 0.9693 |
| +⅙ color | 34.77 dB | 0.9682 |

In Table 1, “+¼” means that the hint frame is ¼ the full-resolution frame size of in each direction (resulting in a pixel area 1/16 the full-resolution pixel area). Similarly, “+⅙” means that the hint frame is ⅙ the full-resolution frame size of in each direction (resulting in a pixel area 1/36 the full-resolution pixel area).

As depicted in FIG. 8A, with the extra hint frame, the interpolation results may be greatly enhanced. An advantage of the hint frame is its ability to help the trained VFI model better place objects in the frame. It is up to the interpolation model then to fill in details. The VFI approach disclosed herein is able to maintain a correct coloring of the hand (although it has a little bit of difficulty in interpolating fine details). Given the lower resolution of the hint frame, it might be expected that the video interpolation method would benefit from improvement to aid in the detail reconstruction. Even with the use of a smaller size hint frame (⅙ of the full-resolution dimensions in both width and height) in color, the reconstructed frame looks much better perceptually than the reconstructed frame with the use of a larger size grayscale hint frame (e.g., ¼ of the full-resolution dimensions in both width and height).

With respect to video compression, Tables 2A and 2B presents quantitative data regarding test results against a Vimeo90K test and four SNU-FILM tests (easy, medium, hard, and extreme). Some data relates to CAIN VFI techniques, XVFI VFI techniques, and ABME VFI techniques as discussed above. Some additional data relates to “Depth-Aware video frame INterpolation” (DAIN) VFI approaches (as discussed in Wenbo Bao, Wei-Sheng Lai, Chao Ma, Xiaoyun Zhang, Zhiyong Gao, and Ming-Hsuan Yang, 2019, Depth-Aware Video Frame Interpolation, In IEEE Conference on Computer Vision and Pattern Recognition). Other additional data relates to “Intermediate Feature Refine Network” (IFRNet) VFI approaches (as discussed in Lingtong Kong, Boyuan Jiang, Donghao Luo, Wenqing Chu, Xiaoming Huang, Ying Tai, Chengjie Wang, and Jie Yang, 2022, IFRNet: Intermediate Feature Refine Network for Efficient Frame Interpolation, In Proceedings of the IEEE/CVF Conference on Computer Vision and Pattern Recognition (CVPR)).

For the CAIN, DAN, XVFI, ABME, and IFRNet VFI approaches, raw frames were used as input, and for the VFI technique disclosed herein, H.264 compression was used (with QP set to 23) to arrive at decompressed input frames.

TABLE 2A
Video compression comparison of different VFIs

| VFI | Training | Vimeo90K |
|---|---|---|
| approach | Dataset | test |
| CAIN | Vimeo90k | 34.65/0.9730 |
| DAIN | Vimeo90k | 34.71/0.9756 |
| XVFI[ | Vimeo90k | 35.07/0.9760 |
| ABME | Vimeo90k | 36.18/0.9805 |
| IFRNet | Vimeo90k | 35.80/0.9794 |
| VFI herein | Vimeo90k | 36.82/0.9784 |

TABLE 2B
Video compression comparison of different VFIs (cont'd)

| VFI | SNU-FILM | SNU-FILM | SNU-FILM | SNU-FILM |
|---|---|---|---|---|
| approach | (easy) | (medium) | (hard) | (extreme) |
| CAIN | 39.89/0.9900 | 35.61/0.9776 | 29.90/0.9292 | 24.78/0.8507 |
| DAIN | 39.73/0.9902 | 35.46/0.9780 | 30.17/0.9335 | 25.09/0.8584 |
| XVFI[ | 39.76/0.9991 | 35.12/0.9769 | 29.30/0.9245 | 23.98/0.8417 |
| ABME | 39.59/0.9901 | 35.77/0.9789 | 30.58/0.9364 | 25.42/0.8639 |
| IFRNet | 40.03/0.9905 | 35.94/0.9793 | 30.41/0.9358 | 25.05/0.8587 |
| VFI herein | 36.97/0.9504 | 35.75/0.9450 | 33.94/0.9298 | 32.31/0.9096 |

For the SNUFILM dataset, SNU-FILM (Easy) is easiest for midpoint frame interpolation. As is shown, all VFI techniques achieved good performance in generating high-quality target frames. However, for the VFI technique disclosed herein, the use of the resampled hint frame made it difficult for our model to fully capture fine details, resulting in average performance. On the Vimeo90K testing dataset, the VFI technique disclosed herein performed slightly better than other methods. For SNUFILM (Medium) with a temporal distance of 2 between keyframes and target frames, the motion in the triplets is larger. The VFI technique disclosed herein performed on par with other methods, with IFRNet yielding the highest performance and ABME coming in second. However, for SNU-FILM (Hard) and SNU-FILM (Extreme), due to the large temporal distances between the keyframes and the target frames (e.g., 4 and 8 respectively), more areas are occluded around the edges of the motion, making it difficult for other methods to capture useful information from keyframes to generate the correct target frames. The VFI technique disclosed herein, with guidance from the low-resolution hint frame, is still able to interpolate frames with high quality even when using H.264 processed keyframes as input. This performance is relatively stable across the Vimeo90K and SNU-FILM (Easy and Medium) datasets, when the motion is small to medium.

As depicted in FIGS. 8B and 8C, in evaluating the performance of the VFI technique disclosed herein, seven videos with a resolution option of 1920×1080 pixels from the open Ultra Video Group (UVG) dataset were used, e.g., a “Beauty” video 852, a “Bosphorus” video 854, a “ReadySetGo” video 856, a “ShakeNDry” video 858, a “Honeybee” video 862, a “Jockey” video 864, and a “YachtRide” video 866. Each of these videos has more than 300 frames and is captured at 50/120 fps (with the first 99 frames from each video being used for testing). A video sequence from the Xiph.org Video Test Media dataset 1 was also used, e.g., a “Tango” video 868. That video is a sequence with lots of motion being captured at 60 fps and has 294 frames (with the first 99 frames from that video being used for testing as well). The final evaluation dataset has various degrees of motion categories such as local motion, global motion, crowded motion, and so on.

The videos were encoded with a QP set to 23 and a GOP size of 16, and each GOP was processed individually (with the GOPs being groups of pictures that have all B-frames, with merely the first frame being an I-frame, and two consecutive GOPs sharing one I-frame between them). This setting was chosen because it aligns with the nature of the VFI technique disclosed herein, in order to have intermediate frames merely use the direct surrounding I-frames for reference.

The VFI techniques are evaluated our method based on the compression rate, as measured by bits per pixel (BPP), and the quality of compression, as PSNR. BPP is an objective measure that indicates an amount of data required to represent an image or video. A lower BPP value indicates better compression efficiency, while a higher PSNR value indicates a high visual quality of the generated frame. Since hint frames were used to guide the VFI process, both high-resolution keyframes and low-resolution hint frames were counted for BPP calculation.

FIGS. 8B and 8C show video compression performance on all eight video sequences tested, with BPP being on the x-axes and PSNR being on the Y-axes. The tests focus on a BPP range from 0.0 to 0.4 in our evaluation, and the bitstream of the VFI technique disclosed herein merely consists of the decompressed keyframes and the low quality hint frames. For the video compression performance, solid lines represent video compressed in accordance with the H.264 standard, dotted lines represent the performance of the VFI technique disclosed herein (with dashed-and-dotted lines representing the performance of the hint frames themselves).

For video sequences that have a relatively large amount of fine detail, e.g., Bosphorus video 854, ReadySetGo video 856, YachtRide video 866, the VFI technique disclosed herein outperforms H.264 merely in the low BPP range. This is because the VFI technique disclosed herein uses an extra hint frame for guidance, and therefore may not be disposed to capturing fine details as well as H.264. However, for video sequences with more significant motion and/or fewer details, like Beauty video 852, Honeybee video 862, and ShakeNdry video 858, the VFI technique disclosed herein model outperforms mere H.264 performance easily. This is because the VFI technique disclosed herein can take advantage of the extra hint frame, providing a more accurate prediction of the video frames, resulting in better compression performance.

Overall, the VFI technique disclosed herein shows comparable performance with H.264 for many sequences and tends to perform better for very low bit-rate applications (e.g., less than 0.05 BPP). Accordingly, the VFI technique disclosed herein demonstrates promising results for low bit-rate applications, and could be a valuable addition to the current video compression standards. It can be used in various applications where low bit-rate is a crucial factor, such as video transmission over low-bandwidth networks or storage on limited-capacity devices.

This disclosure accordingly provides support for a method comprising: receiving a series of input video frames including a first frame, a second frame, and a third frame at a predetermined temporal position between the first frame and the second frame, the first frame having a first resolution, the second frame having a second resolution, and the third frame having a third resolution lower than the first resolution and the second resolution, providing the first frame, the second frame, and the third frame to a trained Video Frame Interpolation (VFI) model, and generating, with the trained VFI model, an interpolated frame at the predetermined temporal position between the first frame and the second frame, the interpolated frame having the first resolution. In a first example of the method, the first frame, the second frame, and the third frame are compressed. In a second example of the method, optionally including the first example, the first frame, the second frame, and the third frame are compressed in compliance with an H.26x video compression standard. In a third example of the method, optionally including one or both of the first and second examples, the third resolution is less than the size of the first resolution (e.g., no more than ¼ the size of the first resolution along both an X-axis and a Y-axis or between ¼ to ½ the size of the first resolution along both an X-axis and a Y-axis), e.g., to trade off bit rate and quality. In a fourth example of the method, optionally including one or more or each of the first through third examples, the method further comprises: prior to providing the third frame to the trained VFI model, upscaling the third frame to the first resolution. In a fifth example of the method, optionally including one or more or each of the first through fourth examples, the third frame is upsampled via pixel replication. In a sixth example of the method, optionally including one or more or each of the first through fifth examples, the method further comprises: prior to providing the first frame, the second frame, and the third frame to the trained VFI model, concatenating the first frame, the second frame, and the third frame in a channel-wise manner. In a seventh example of the method, optionally including one or more or each of the first through sixth examples, the method further comprises: prior to concatenating the first frame, the second frame, and the third frame in the channel-wise manner, downshuffling the first frame, the second frame, and the third frame. In an eighth example of the method, optionally including one or more or each of the first through seventh examples, the method further comprises: receiving an indicator to disable a use of the third frame, the indicator having a first predetermined value representing disabling the use of the third frame and a second predetermined value representing enabling the use of the third frame, wherein providing the first frame, the second frame, and the third frame to the trained VFI model is dependent upon a value of the indicator matching the second predetermined value.

This disclosure also provides support for a method for interpolating video frames, the method comprising: receiving a series of input video frames including a first higher-resolution frame having a first temporal position of the series, a second higher-resolution frame having a second temporal position of the series, and a lower-resolution intermediate frame having an intermediate temporal position of the series between the first temporal position and the second temporal position, upscaling the lower-resolution intermediate frame to create an upscaled intermediate frame, concatenating the first higher-resolution frame, the second higher-resolution frame, and the upscaled intermediate frame to produce a concatenated frame, inputting the concatenated frame to a trained video frame interpolation (VFI) model, and outputting an interpolated frame from the trained VFI model, the interpolated frame having the intermediate temporal position of the series. In a first example of the method, a resolution of the lower-resolution intermediate frame is no more than ¼ the size of a resolution of the first higher-resolution frame, along both an X-axis and a Y-axis. In an alternate example of the method, a resolution of the lower-resolution intermediate frame is between ¼ to ½ the size of a resolution of the first higher-resolution frame, along both an X-axis and a Y-axis. In a second example of the method, optionally including the first example, a resolution of the first higher-resolution frame, a resolution of the second higher-resolution frame, and a resolution of the lower-resolution intermediate frame are the same. In a third example of the method, optionally including one or both of the first and second examples, the upscaling of the lower-resolution intermediate frame is via pixel replication. In a fourth example of the method, optionally including one or more or each of the first through third examples, the concatenating of the first higher-resolution frame, the second higher-resolution frame, and the upscaled intermediate frame is in a channel-wise manner. In a fifth example of the method, optionally including one or more or each of the first through fourth examples, the method further comprises: after the upscaling of the lower-resolution intermediate frame, downshuffling the first higher-resolution frame, the second higher-resolution frame, and the upscaled intermediate frame.

This disclosure also provides support for a system for interpolating video frames, comprising: a trained video frame interpolation (VFI) model, and one or more processors, and a non-transitory memory having executable instructions that, when executed, cause the one or more processors to: receive a first high resolution frame, a second full-resolution, and a lower-resolution intermediate frame at a temporal position between the first full-resolution and the second full-resolution, upscale the lower-resolution intermediate frame to create an upscaled intermediate frame, a resolution of the upscaled intermediate frame being the same as a resolution of the first full-resolution and the second full-resolution, concatenate the first full-resolution, the second full-resolution, and the upscaled intermediate frame into a concatenated frame, provide the concatenated frame to the trained VFI model, and output an interpolated frame at the temporal position, a resolution of the interpolated frame being the same as the resolution of the first full-resolution and the second full-resolution. In a first example of the system, the first full-resolution, the second full-resolution, and the lower-resolution intermediate frame are compressed in compliance with a video compression standard selected from: the H.264 Advanced Video Coding (AVC) standard, and the H.265 High Efficiency Video Coding (HEVC) standard. In a second example of the system, optionally including the first example, the upscaling of the intermediate hint frame is via pixel replication. In a third example of the system, optionally including one or both of the first and second examples, the concatenating of the first full-resolution, the second full-resolution, and the upscaled intermediate frame is in a channel-wise manner. In a fourth example of the system, optionally including one or more or each of the first through third examples the executable instructions, when executed, further causing the one or more processors to: prior to concatenating the first full-resolution, the second full-resolution, and the upscaled intermediate frame, downshuffle the first full-resolution, the second full-resolution, and the upscaled intermediate frame.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. A method comprising:
receiving a series of input video frames including a first frame, a second frame, and a third frame at a predetermined temporal position between the first frame and the second frame, the first frame and the second frame having a first resolution, and the third frame having a second resolution lower than the first resolution and the second resolution;
providing the first frame, the second frame, and the third frame to a trained Video Frame Interpolation (VFI) model; and
generating, with the trained VFI model, an interpolated frame at the predetermined temporal position between the first frame and the second frame, the interpolated frame having the first resolution.

2. The method of claim 1, wherein the first frame, the second frame, and the third frame are compressed.

3. The method of claim 2, wherein the first frame, the second frame, and the third frame are compressed in compliance with an H.26x video compression standard.

4. The method of claim 1, wherein a size of the second resolution is less than a size of the first resolution along both an X-axis and a Y-axis.

5. (canceled)

6. (canceled)

7. The method of claim 1, further comprising:
prior to providing the third frame to the trained VFI model, upscaling the third frame to the first resolution.

8. The method of claim 7, wherein the third frame is upsampled via pixel replication.

9. The method of claim 1, further comprising:
prior to providing the first frame, the second frame, and the third frame to the trained VFI model, concatenating the first frame, the second frame, and the third frame in a channel-wise manner.

10. The method of claim 9, further comprising:
prior to concatenating the first frame, the second frame, and the third frame in the channel-wise manner, downshuffling the first frame, the second frame, and the third frame.

11. The method of claim 1, further comprising:
receiving an indicator to disable a use of the third frame, the indicator having a first predetermined value representing disabling the use of the third frame and a second predetermined value representing enabling the use of the third frame,
wherein providing the first frame, the second frame, and the third frame to the trained VFI model is dependent upon a value of the indicator matching the second predetermined value.

12. A method for interpolating video frames, the method comprising:
receiving a series of input video frames including a first higher-resolution frame having a first temporal position of the series, a second higher-resolution frame having a second temporal position of the series, and a lower-resolution intermediate frame having an intermediate temporal position of the series between the first temporal position and the second temporal position;
upscaling the lower-resolution intermediate frame to create an upscaled intermediate frame;
concatenating the first higher-resolution frame, the second higher-resolution frame, and the upscaled intermediate frame to produce a concatenated frame;
inputting the concatenated frame to a trained video frame interpolation (VFI) model; and
outputting an interpolated frame from the trained VFI model, the interpolated frame having the intermediate temporal position of the series.

13. The method for interpolating video frames of claim 12, wherein a size of a resolution of the lower-resolution intermediate frame is less than a size of a resolution of the first higher-resolution frame.

14. (canceled)

15. (canceled)

16. The method for interpolating video frames of claim 12, wherein a resolution of the first higher-resolution frame, a resolution of the second higher-resolution frame, and a resolution of the lower-resolution intermediate frame are the same.

17. The method for interpolating video frames of claim 16, wherein the upscaling of the lower-resolution intermediate frame is via pixel replication.

18. The method for interpolating video frames of claim 12, wherein the concatenating of the first higher-resolution frame, the second higher-resolution frame, and the upscaled intermediate frame is in a channel-wise manner.

19. The method for interpolating video frames of claim 18, further comprising:
after the upscaling of the lower-resolution intermediate frame, downshuffling the first higher-resolution frame, the second higher-resolution frame, and the upscaled intermediate frame.

20. A system for interpolating video frames, comprising:
a trained video frame interpolation (VFI) model; and
one or more processors; and
a non-transitory memory having executable instructions that, when executed, cause the one or more processors to:
receive a first full-resolution, a second full-resolution, and a lower-resolution intermediate frame at a temporal position between the first full-resolution and the second full-resolution;
upscale the lower-resolution intermediate frame to create an upscaled intermediate frame, a resolution of the upscaled intermediate frame being the same as a resolution of the first full-resolution and the second full-resolution;
concatenate the first full-resolution, the second full-resolution, and the upscaled intermediate frame into a concatenated frame;
provide the concatenated frame to the trained VFI model; and
output an interpolated frame at the temporal position, a resolution of the interpolated frame being the same as the resolution of the first full-resolution and the second full-resolution.

21. The system for interpolating video frames of claim 20, wherein the first full-resolution, the second full-resolution, and the lower-resolution intermediate frame are compressed in compliance with a video compression standard selected from: the H.264 Advanced Video Coding (AVC) standard; and the H.265 High Efficiency Video Coding (HEVC) standard.

22. The system for interpolating video frames of claim 20, wherein upscaling of the intermediate frame is via pixel replication.

23. The system for interpolating video frames of claim 20, wherein concatenating of the first full-resolution, the second full-resolution, and the upscaled intermediate frame is in a channel-wise manner.

24. The system for interpolating video frames of claim 20, the executable instructions, when executed, further causing the one or more processors to:
prior to concatenating the first full-resolution, the second full-resolution, and the upscaled intermediate frame, downshuffle the first full-resolution, the second full-resolution, and the upscaled intermediate frame.
